(19) United States
(12) Patent Application Publication
(10) Pub. No.: US 2012/0149444 A1
(43) Pub. Date: Jun. 14, 2012

(54) STAND FOR WIRELESS PHONE

(75) Inventors: HUI YUAN, Shenzhen City (CN); ZHI-GANG YANG, Shenzhen City (CN); PING YU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/084,545

(22) Filed: Apr. 11, 2011

(30) Foreign Application Priority Data
Dec. 13, 2010 (CN) 201010584956.2

(51) Int. Cl. H04M 1/04

(52) U.S. Cl. 455/575.1

(57) ABSTRACT

A stand for a wireless phone having a wireless emitter is provided. The stand includes a base, a wireless receiver for communicating with the wireless emitter, a control circuit, a rotatable body, and a driving mechanism. The base includes a wireless receiver communicating with the wireless emitter, and a control circuit. The rotatable body is rotatably connected to the base and includes an indicator. The driving mechanism is received in the base, to drive the rotatable body to rotate. The control circuit is to activate the driving mechanism in response to the signals received by the wireless receiver from the wireless emitter to drive the rotatable body to rotate, until the indicator indicates a direction of the wireless phone that is away from the stand.

### BACKGROUND

1. Technical Field

The present disclosure relates to a stand for a wireless phone.

2. Description of Related Art

A wireless phone can be placed on a base when not in use. However, sometimes, a user may forget to put the wireless phone back to the base after using the wireless phone. As a result, it is usually hard to locate the wireless phone when needed.

Therefore, what is needed is a stand for a wireless phone to alleviate the limitations described above.

### BRIEF DESCRIPTION OF THE DRAWINGS

The components in the drawings are not necessarily drawn to scale, the emphasis instead being placed upon clearly illustrating the principles of a stand for a wireless phone. Moreover, in the drawings, like reference numerals designate corresponding parts throughout the several views.

FIG. 1 is an isometric view of an exemplary embodiment of a stand for a wireless phone.

FIG. 2 is an exploded view of the stand of FIG. 1.

FIG. 3 is another exploded view the stand of FIG. 1, viewed from a different perspective.

FIG. 4 is a cross-sectional view of the stand of FIG. 1, taken along lines of IV-IV.

### DETAILED DESCRIPTION

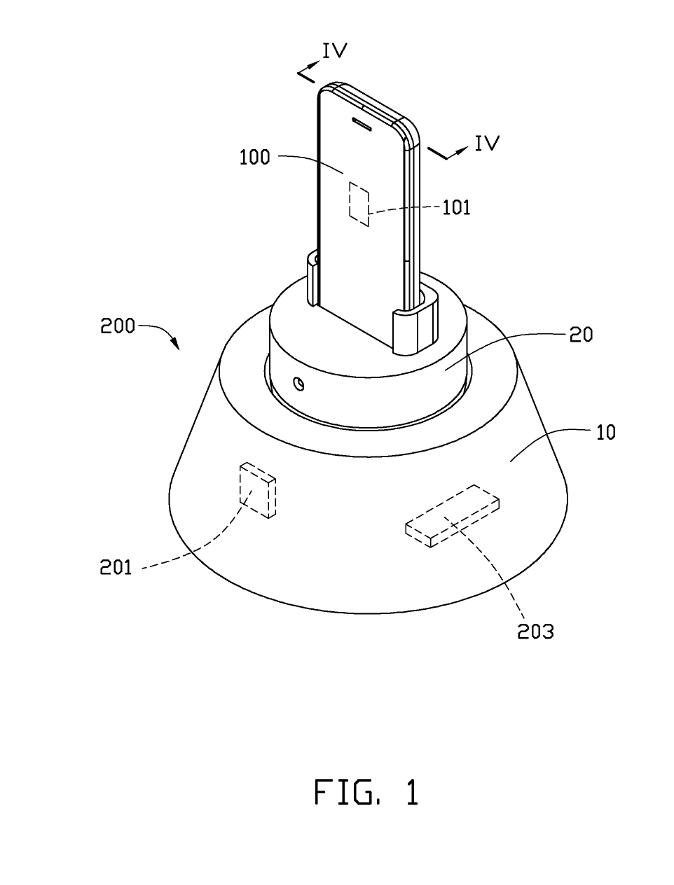

Referring to FIG. 1, a stand 200 for a wireless phone 100 is disclosed as an exemplary embodiment. The stand 200 includes a base 10 and a rotatable body 20 whose bottom is rotatably received in the base 10. The wireless phone 100 includes a wireless emitter 101. The base 10 includes a wireless receiver 201 to receive signals emitted from the wireless emitter 101.

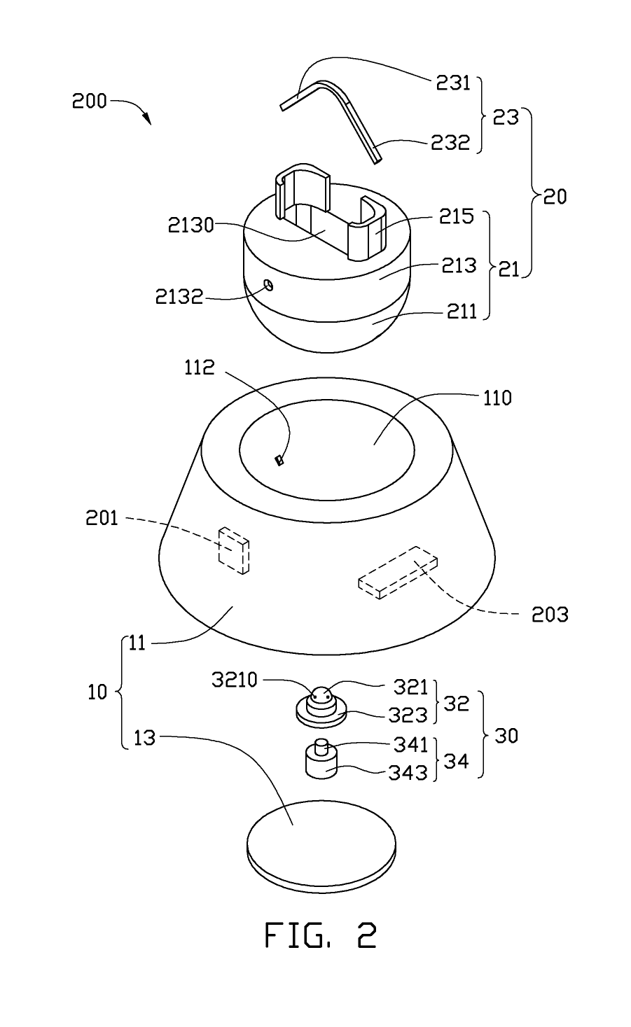

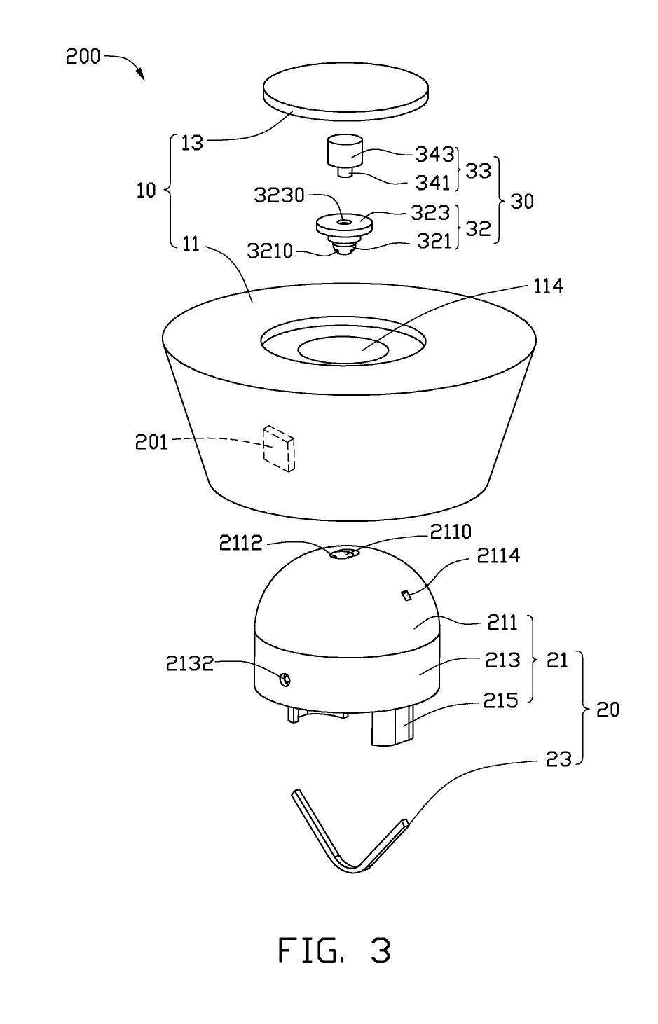

Referring to FIGS. 2 and 3, the rotatable body 20 includes a rotator 21 and an elastic element 23 movably received in the rotator 21. In the embodiment, the elastic element 23 includes two arms 231 and 232 that are substantially perpendicular to each other. However, the shape and configuration of the elastic element 23 is not limited and can be varied according to need. The rotator 21 includes a hemispherical bottom 211, a receiving portion 213 protruding from the bottom 211, and two walls 215 protruding from the top of the receiving portion 213. The bottom 211 defines a cavity 2110 defining a number of recesses 2112. In this embodiment, the number of the recesses 2112 is four. The recesses 2112 are evenly arranged in the cavity 2110. The outer circumferential sidewall (not labeled) of the receiving portion 213 includes an indicator 2132 close to the wireless receiver 201. One end of the receiving portion 213 away from the bottom 211 defines a space 2130 for fitting a portion of the wireless phone 100 and receiving the portion of the wireless phone 100. The two walls 215 are arranged at opposite edges of the space 2130, and prevent the wireless phone 100 from disengaging from the stand 200.

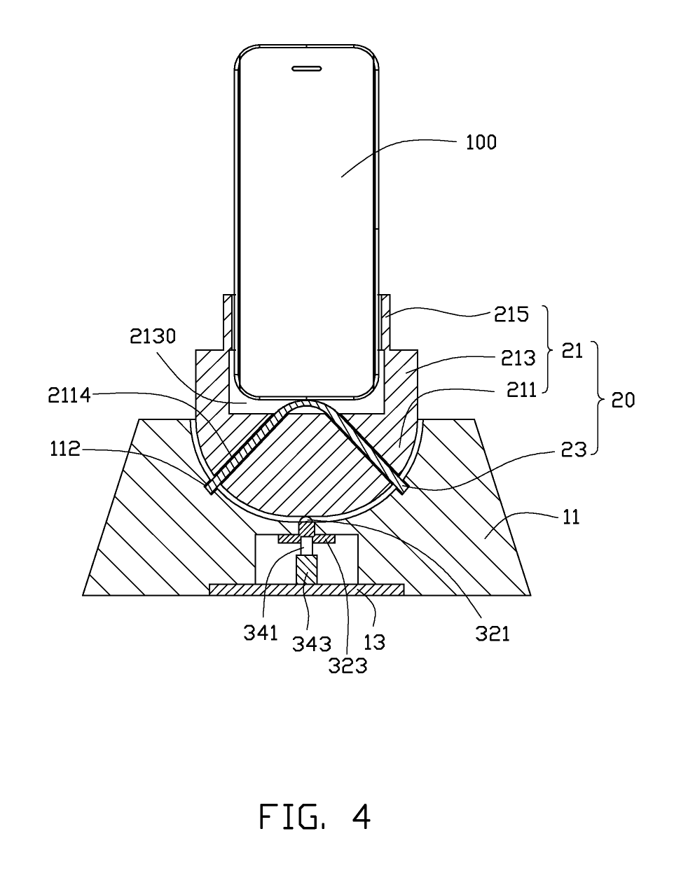

Referring to FIG. 4, the bottom 211 further defines two receiving grooves 2114 both communicating with the space 2130. The receiving grooves 2114 extend through the bottom 211 and are used to receive the arms 231 and 232, respectively.

Referring back to FIGS. 2 and 3, the base 10 includes a body 11 and a cover 13. The body 11 defines a receiving space 110 in the top of the body 11. The size of the receiving space 110 is slightly larger than that of the bottom 211 of the rotatable body 20. The receiving space 110 can thus receive the bottom 211 therein. The bottom 211 can rotate in the receiving space 110. The inner sidewall of the receiving space 110 defines two recesses 112. The recesses 112 are used to receive the two ends of the elastic element 23 when the wireless phone 100 is received in the rotatable body 20. The base 10 defines a stepped hole 114 in the bottom of the body 11. The stepped hole 114 communicates with the receiving space 110. The cover 13 is fitted in a larger portion of the stepped hole 114.

The base 10 further includes a control circuit 203. The control circuit 203 is electrically connected with the wireless receiver 201, and the indicator 2132, for controlling the rotatable body 20 to rotate.

The stand 200 further includes a driving mechanism 30 received in the base 10 and rotatably connecting the rotatable body 20 to the base 10. The driving mechanism 30 includes a hollow rotary joint 32 and a motor 34 connected to the rotary joint 32. The rotary joint 32 includes a chassis 323 and a supporting element 321 which protrude from the chassis 323 and are received in the cavity 2110. The supporting element 321 includes four protrusions 3210 fitted in the four recesses 2112 of the cavity 2110, thus engaging with the bottom 211 to drive the rotator 21 to rotate. The chassis 323 defines an axle hole 3230 in the center of the bottom. The motor 34 includes a motor body 343 fixed in the receiving space 110, and a driving shaft 341 received in the axle hole 3230. The driving shaft 341 drives the rotary joint 32 to rotate when the motor 34 is activated. The rotary joint 32 drives the rotator 21 to rotate.

Referring back to FIG. 4, when the wireless phone 100 is received in the rotatable body 20, two ends of the elastic element 23 extend through the receiving grooves 2114, respectively, and are received in the recesses 112, thus holding the rotator 21. Two ends of the elastic element 23 retract into the two receiving grooves 2114 respectively from the recesses 112 because of the elastic restoring force generated when the wireless phone 100 has been lifted away from the stand 10.

In use, when the wireless phone 100 has been placed randomly elsewhere and needs to be located, the control circuit 203 can be operated to turn on the indicator 2132, and actuates the wireless receiver 201 and the motor 34. The control circuit 203 controls the motor 34 to rotate, in response to the signals the wireless receiver 201 received from the wireless emitter 101 of the wireless phone 100. The motor 34 drives the rotary joint 32 to rotate, and the rotary joint 32 further drives the rotatable body 20 to rotate, until the indicator 2132 indicates an approximate direction of the wireless phone 100. The control circuit 203 then shuts down the motor 34. The user can then get an idea of the approximate position of the wireless phone 100 by the indicator 2132.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A stand for a wireless phone having a wireless emitter, the stand comprising:
a base;
a wireless receiver for communicating with the wireless emitter;
a control circuit;
a rotatable body rotatably connected to the base and comprising an indicator; and
a driving mechanism received in the base, to drive the rotatable body to rotate;
wherein the control circuit is to actuate the driving mechanism in response to the signals received by the wireless receiver from the wireless emitter to drive the rotatable body to rotate, until the indicator indicates a direction of the wireless phone that is away from the stand.

2. The stand as described in claim 1, wherein the rotatable body includes a bottom received in the base and defining a cavity, and a receiving portion protruding from the bottom and defining a space; the driving mechanism comprises a rotary joint and a motor connected to the rotary joint and fixed in the base, the rotary joint comprises a chassis defining an axle hole, and a supporting element protruding from the chassis and received in the cavity to engage with the rotatable body; and a driving shaft of the motor is received in the axle hole.

3. The stand as described in claim 2, wherein the bottom further defines two receiving grooves extending through the bottom both communicating with the space, the rotatable body further comprises an elastic element movably received in the two receiving grooves and the space, and when the wireless phone is placed on the stand, the elastic element is pressed by the wireless phone to move through the two receiving grooves.

4. The stand as described in claim 3, wherein two arms of the elastic element are movably received in the two receiving grooves correspondingly.

5. The stand as described in claim 4, wherein the base defines a receiving space in the top, the size of the receiving space is slightly larger than that of the bottom of the rotatable body, and the bottom is received in the receiving space.

6. The stand as described in claim 5, wherein an inner sidewall of the receiving space defines two recesses to receive two ends of the two arms of the elastic element correspondingly when the elastic element is pressed to cause the two ends of the two arms of the elastic element to move out of the bottom via the two receiving grooves.

7. The stand as described in claim 2, wherein the cavity defines a plurality of recesses, and the supporting element comprises a plurality of protrusions to engage in the plurality of recesses correspondingly.

8. The stand as described in claim 2, wherein the bottom is hemispherical.

9. The stand as described in claim 2, wherein the rotatable body further comprises two walls protruding from the top of the receiving portion and bounding the space.

10. The stand as described in claim 2, wherein the indicator is allocated on an outer sidewall of the receiving portion.
